(19) United States
(12) Patent Application Publication
(10) Pub. No.: US 2007/0048693 A1
(43) Pub. Date: Mar. 1, 2007

(54) Educational system and tools

(76) Inventor: Patty Hannan, Rockwall, TX (US)

Correspondence Address: EUGENIA S. HANSEN;HEMINGWAY & HANSEN, LLP, BANK ONE CENTER-SUITE 2500, 1717 MAIN STREET, DALLAS, TX, 75201, US

(21) Appl. No.: 11/200,695

(22) Filed: Aug. 10, 2005

(51) Int. Cl. G09B 19/00

(52) U.S. Cl. 434/156

(57) ABSTRACT

A method for education and a system for implementing the method is disclosed. In particular, the method involves accessing, recognizing, engaging and enhancing development of natural cognitive ability (particularly in infants, babies, toddlers and young children and the learning handicapped). The method utilizes a flash image (visual) and auditory system designed to stimulate development of core cognitive skills essential for learning (attention, recognition and short term memory skills), language development (vocabulary, word association and word expansion), and visual development (focus, tracking, visual acuity, discrimination and directionality skills). The flash image/auditory system comprises two to seven specific components including interactive components. Each component can be modified and presented as a separate embodiment to aid in progression of skill development for learning or recognizing the final embodiment for that component or for enhancing learning ability for that component. The ‘flash’ aspect of the method indicates a desired speed and/or rhythm requirement for the method to be most effective. The invention employs or utilizes a flash card format or computer, DVD and book formats.

### FIELD OF THE INVENTION

This invention relates in general to the field of education in human subjects, more specifically to the cognitive abilities of learning, language and visual skills in the young child or learning disabled.

### BACKGROUND OF THE INVENTION

Cards, flash cards, videos and books to stimulate basic learning and recognition skills for infants, babies, toddlers and the young child are abundantly available. They have been used to present basic concepts for recognizing shapes, colors, numbers, alphabet and general subject recognition by type such as, for example, animals, vehicles, plants, etc. and for developing reading and math skills. These systems rely heavily on visual and auditory cognitive functions as well as perceiving the object/subject in the static upright orientation. Some educational materials have attempted to appeal to the young child by providing brighter pictures, bigger letters and thicker pages, for example. However, heretofore known systems have not provided a specific developmental method for progressively stimulating cognitive ability. Tools and methodology to optimize the desired cognitive stimulation have now been developed according to the present invention.

### SUMMARY OF THE INVENTION

In a preferred embodiment, the invention is a method of education comprising: presenting to a learner a set of images which provide a mental understanding of a concept concurrently with an auditory pronouncement. The image and auditory pronouncement is presented in two seconds or less to the learner, so that when a user views all of the set members in a preselected order, the mental recognition of the concept is imparted to the user. The preferred concepts are selected from building a mental image from component parts, foundation attributes (color, shape, size and number), focus and visual tracking, functional attributes, visual acuity, visual discrimination, and visual directionality. In a most preferred ebmodiment, all of the preferred concepts are presented to a user.

Another embodiment of the invention is an educational system which is comprised of sets of images that can be used in the method of the invention.

### BRIEF DESCRIPTION OF THE DRAWINGS

FIGS. 1a, 1b, 1c & 1d represent a ‘build it’ component of the flash image/auditory system.

FIGS. 2a, 2b, 2c, 2d, 2e, 2f, 2g & 2h represent a ‘foundation attributes’ component of the flash image/auditory system.

FIGS. 2a, 2b, & 2c represent a ‘number subset’ of the ‘foundation attributes’ component of the flash image/auditory system.

FIGS. 2d & 2e represent a ‘size subset’ of the ‘foundation attributes’ component of the flash image/auditory system.

FIGS. 2f, 2g & 2h represent a ‘color subset’ of the ‘foundation attributes’ component of the flash image/auditory system.

FIGS. 3a, 3b, 3c & 3d represent a ‘search focus and visual tracking’ component of the flash image/auditory system.

FIGS. 4a, 4b & 4c represent a ‘functional attributes’ component of the flash image/auditory system.

FIGS. 5a and 5b represent a ‘visual acuity’ component of the flash image/auditory system.

FIGS. 6a and 6b represent the ‘visual discrimination’ component of the flash image/auditory system.

FIGS. 7a & 7b represent the component of ‘visual directionality’ in the flash image/auditory system.

FIG. 8a-8e represents an example of the outline ‘build it’ component of the flash image/auditory system.

FIG. 9a-9d represents an example of the parts ‘build it’ component of the flash image/auditory system.

FIG. 10 represents an example of the fraction ‘build it’ component of the flash image/auditory system.

FIG. 11 represents an example of the modified shape ‘build it’ component of the flash/auditory system.

### DETAILED DESCRIPTION OF THE PREFERRED EMBODIMENTS

Recently, brain function, development and cognitive research have uncovered many new understandings concerning the young brain and its potential ability. While the debate rages on about how and when to start a formalized learning program with infants and toddlers, most experts now agree that babies are born with the ability to learn. Just as it is known that babies are born with motor reflexes (which are tested at birth to assure proper neurophysiologic function) it is now recognized that babies are born with cognitive instincts to assist their ability to learn the information essential for survival about their world. It is also now recognized that the brain grows and learns at an unprecedented speed in the early years and that lack of proper stimulation during this period can lead to cognitive disabilities that are later difficult to overcome or may last a lifetime and conversely, that age appropriate stimulation during key developmental periods can ease and enhance the learning process.

The present invention provides a new basic educational system/method and tools which employ sensory integration to maximize the learning experience. Visual, auditory and kinesthetic learning styles (sensory integration) are employed within the presentation of the method to provide an effective step-by-step learning experience for developing cognitive function from infants to the young child (and learning disabled). Specific natural cognitive abilities that the system/method purposefully stimulates includes the foundation skills for learning; attention, recognition and short term memory; implicit memory skills; habituation, recognition and novelty; cognitive instincts for classifying objects; recognizing amounts can increase and decrease; that objects can be perceived by shape, size, number and color; that the brain naturally seeks out an anomaly; development of language skills through use of ‘parentese’, word association, word expansion and dialogic reading techniques; and the visual skills of focus, tracking, visual acuity, visual discrimination and recognition of directionality. All the above, combined with a novel method of presentation (flash image/auditory method) using speed, rhythm, repetition and the visual skill ability to seek and track, create a new method for engaging and developing a young child's natural cognitive ability while interacting with them at an interpersonal level filled with positive reinforcement and mutual respect. The method has an interactive component that creates a sense of achievement when the child has an opportunity to demonstrate competency in a task and is rewarded for it. Learning is fun, interactive and exciting, prompting the desire to enjoy learning for a lifetime.

This present invention can also be used as a method for recognizing ability and identifying levels of ability.

Various media can be used to present images in sets, in accordance with the invention. In one embodiment, a set displays images on cards which are used to present the components to the learner. Preferably, sturdy card stock is employed and it is most preferably laminated for durability. The preferred size of the cards is 8½ inches by 8½ inches square, but other sizes can be used. The card should be sized for ease of handling. The image on the card should be in the range of from about ½ inches to about 4 inches so that the image can be seen clearly by the learner. The components may also be presented in book formats. Electronic media may also be used to present the educational method. For example, a video, DVD or computer program can present the visual and audio aspects of the components of the method to the learner. The electronic media may be designed to provide the presentation timing that is part of the method. The electronic media can also present the components of the method in an entertainment format combining the components and/or the component parts in a format designed to cognitively stimulate and engage the interest of the viewer. Computer programs can provide an interactive component to electronic media. For example, a touch screen, keyboard, or console may provide means for the learner to provide interaction. The computer program may also take the input made by the learner and use that data to select appropriate additional components to present to the learner. Audio tapes or CD's can be used with accompanying visual material in book or card formats. For example, the audio tape may provide a signal to turn the page or change the card along with the auditory accompanying the visual display. It is most preferred that the presentation be interactive and that there be a method to observe the learner's focus and mastery of the components.

A single subject is presented to the learner who may observe an image or images on a visual field. The portion of the card, page or screen that can be observed by the learner is the visual field. The way the subject is presented is changed during the method of the invention as defined within the prescribed components. The change is by structure (viewing parts to whole of subject), certain attributes (such as color, shape, size and number) function or location of the subject and/or by passive or active participation in perceiving the subject. Quick, rhythmical repetition of the subject and its variations, with accompanying word association, presentation of the subject construction, attributes and function and the further challenges of visually locating, tracking, discriminating and recognizing the directionality of the subject causes the learner's brain to ‘hold’ the image in storage for continual processing and updating of recognition, thereby stimulating memory ability. The presenter, program or prerecorded presentation may predetermine the order desired for the presentation of the images and accompanying auditory. The image is visual, the word association is auditory, the visual locating and tracking is kinesthetic (eye muscle control), thereby employing the concept of sensory integration further enhancing the learning experience. It is preferred that each component of the system be further modified to enhance the focus of the learning experience of that component creating additional ‘card sets’. Each set, employing tools to promote a single component of the method as more fully described below, can be presented to the learner. It is further preferred that in the final embodiment all sets use the same format so the learner can anticipate presentation of the prescribed components and their associated attributes, further enhancing learning ability. However, the order of the components can be interchanged to create a novel learning experience which also enhances learning ability.

The present invention allows even infants and babies to begin developing specific, age appropriate cognitive skills. Parents and teachers are also able to observe the level of attention and progressive development of the various skills by watching the baby's eyes, respiration, increases in sucking and/or limb movements to confirm awareness and then eventually their ability to point out a correct response either by visual focus or focus and hand reaching or finger pointing.

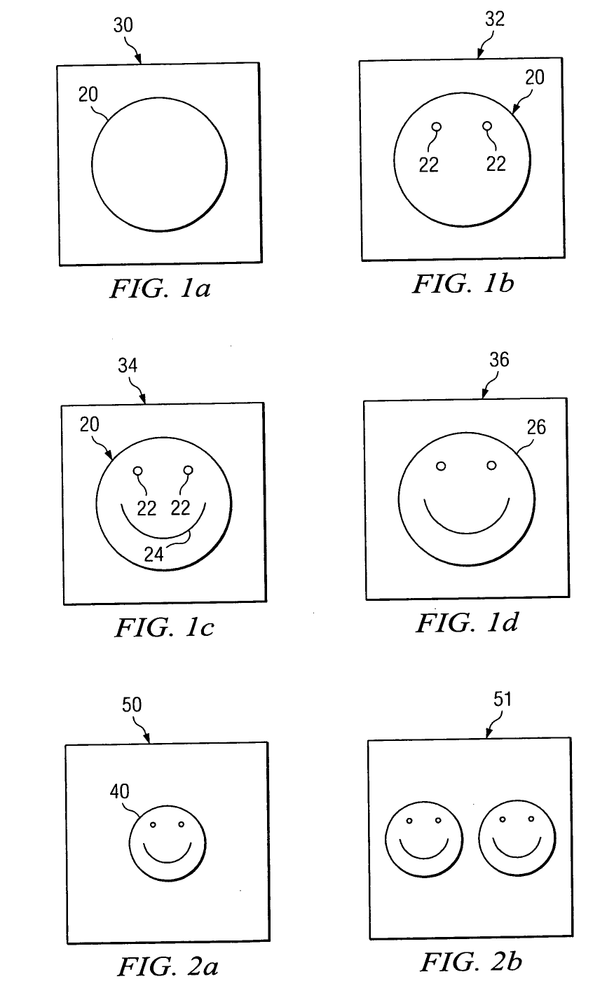

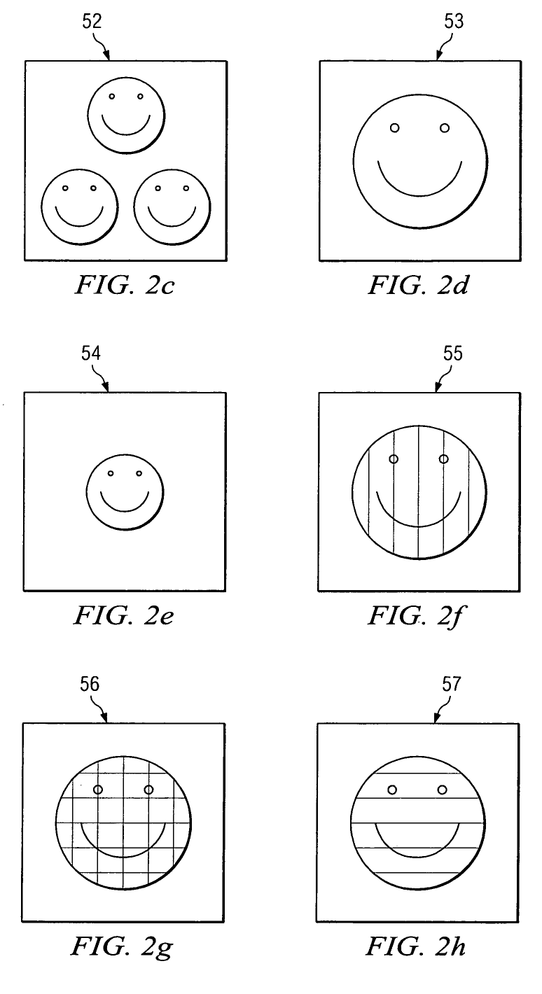

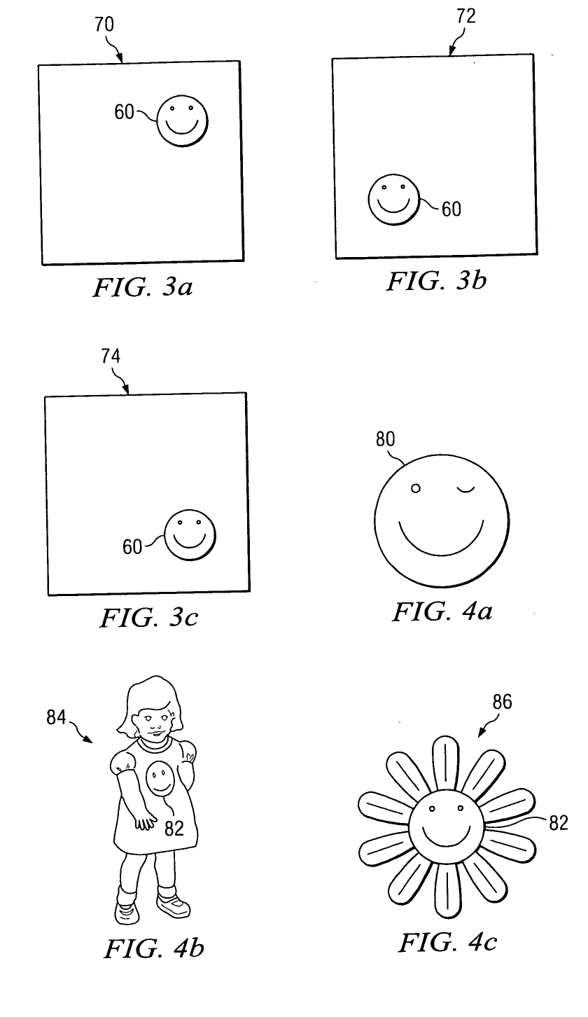

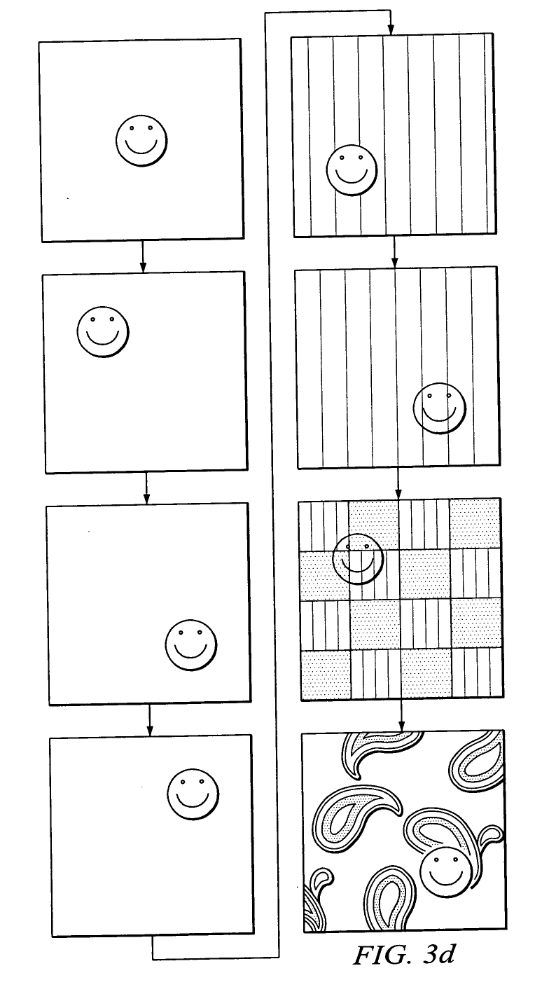

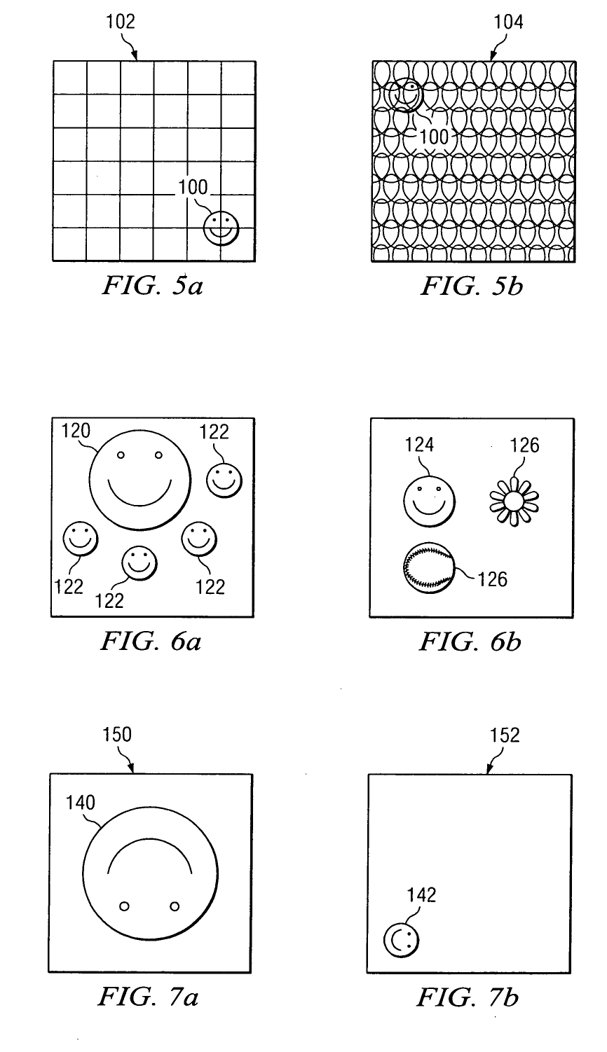

In a preferred embodiment, the system includes 7 components. Components 1 through 4 (FIG. 1, FIG. 2, FIG. 3, FIG. 4) are passive components that require only the child's observation and attention for presentation. Components 5, 6 and 7 (FIG. 5, FIG. 6, FIG. 7) are interactive and require a specific level of interaction and response. Images should be clear, defined, single, uncluttered, image(s) of the subject.

Components 1 through 4 of the method are most preferably presented with a specific speed and rhythm for the best effectiveness. Each image should be flashed no less than 2 seconds per image and no faster than the associated word(s) can be clearly pronounced for that image. Dictation of the words for each component should posses a rhythm (‘parentese’) that helps define the beginning and end of each component. For example, while the speed for flashing the cards is consistent the vocal intonation should posses a rhythm (‘parentese’) defining the components “CIRCLE, EYES, MOUTH” (each word in caps same tone and rhythm) “SMILEY FACE!” (words followed by “!” are given in a higher pitched and animated vocal one/rhythm).

Components 5 through 7 are preferably presented to the child as described in the examples.

The components can be modified to enhance the learning experience and/or provide further developmentally appropriate cognitive stimulation for that component. The present invention can be modified as described below:

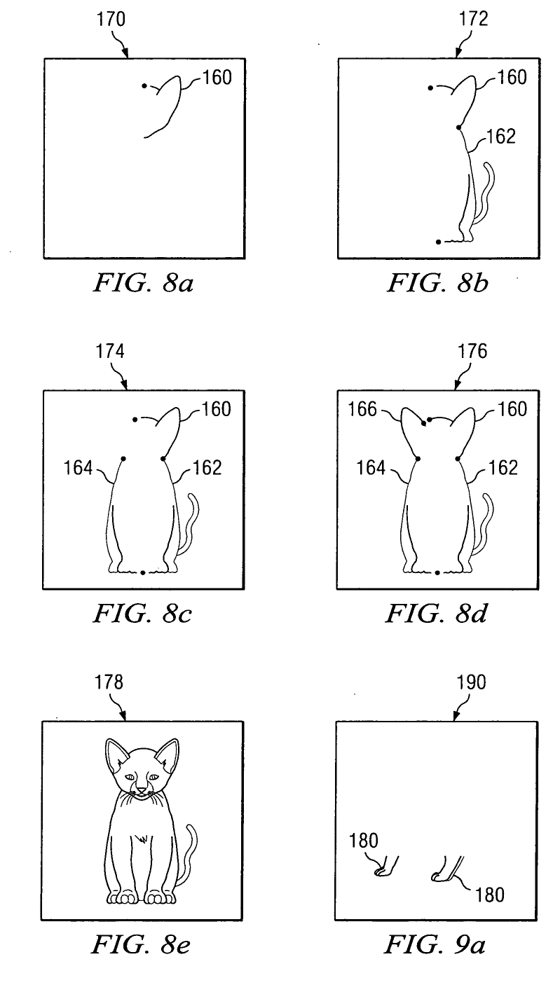

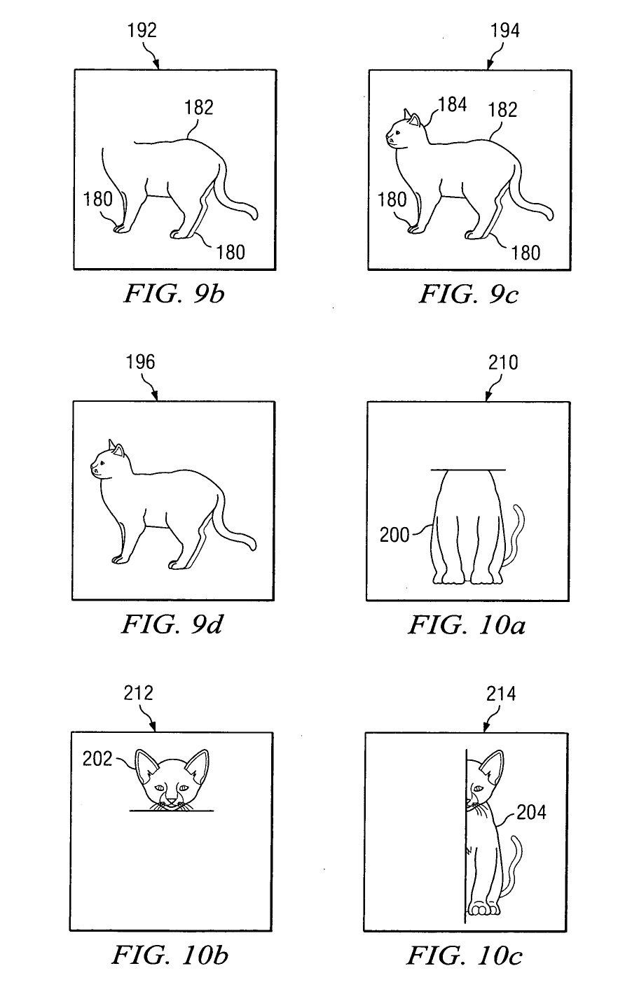

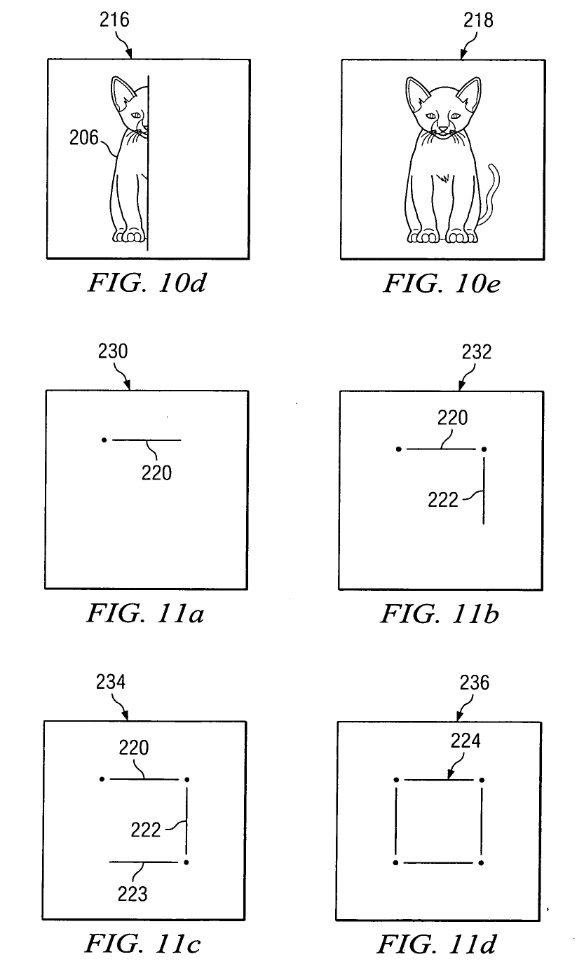

Component 1 (FIG. 1) of the method is a “build it” component. A subject (object or shape or word) 26 is chosen for presentation and the subject is then presented in portions 20, 22, 24 to the learner which together comprise recognition of the subject matter. This can be done by outline, fraction or part (for word recognition this would be by single letters than by phonetic pronouncement) that together ‘build’ recognition of the subject matter. For example (FIG. 8), ‘cat’ 178 can be ‘built’ by presenting in progressive succession of four lines of roughly equal length 160, 162, 164, 166 that together show an outline of a cat. Or, ‘cat’ 196 can be built by part (referring now to (FIG. 9)), showing legs 180, then adding body 182, then adding head 184 and perception of whole “cat” FIG. 9d. Or, (FIG. 10) ‘cat’ 218 can be ‘built’ by fraction showing bottom half 200, top half 202, right half 204 then left half 206 and finally an image of whole ‘cat’ 218. Or, “cat” can be built by single letters, each letter is presented in order separately, then the word ‘cat’ would be presented phonetically, then presentation of the whole word ‘cat’. For ‘cat’ the letter ‘c’ would first be presented in the same spatial location as if the whole word had been written. Then the letter ‘a’ would be presented in the same spatial location as if the whole word ‘cat’ had been written. Then continue with ‘t’. Then for the phonetic ‘build it’ portion the letter ‘c’ would be presented as the first ‘c’ was, then ‘at’ would be presented in the same spatial location as if the whole word had been written. The pronouncement for each card would be phonetic and finally recognition of the whole word ‘cat’ with the verbal pronouncement ‘cat’.

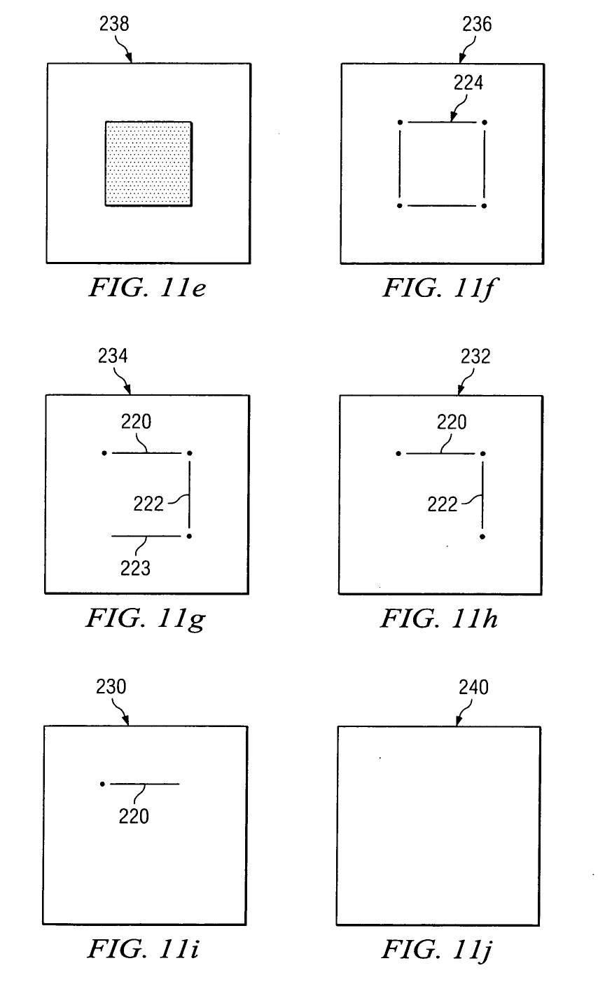

FIG. 11 provides an additional exemplification. The ‘build it’ components can be further modified as a separate learning module by presenting ‘build it’ shapes. This module stimulates recognition of constructing and deconstructing defined images using the above methods. Before an infant or baby can recognize ‘cat’ as a subject they can appreciate the building of shapes. Using lines or parts of lines and arcs any shape can be ‘built’ for the observer. The method will build a square (FIG. 11) adding 1 new line 222 to the original line 220 until a box 224 is created, then a solid square 238 is presented then the process is deconstructed to a blank ‘all gone’ card 240. The ‘build it’ component can be presented as an independent module in the methodology for a focused learning experience of building and deconstructing any entity by outline (FIG. 8), part (FIG. 9) or fraction (FIG. 10). In yet another embodiment of the method, once the whole object is ‘built’ and announced the presenter rotates the card 180 degrees and then back while announcing the name of the subject. Ideally, the card would be rotated in alternate directions each time the card (image) set is presented. Rotating the image stimulates visual tracking and recognition of the subject by orientation.

Component 2 is the “Foundation Attributes” component (FIG. 2). The foundation attributes are color, shape, size and number. Recognition of these attributes is essential to visual perception and cognitive ability and can be considered as ‘hardwired’ in the developing brain. For this component, in a preferred embodiment, the subject is the shape 40. Referring to FIGS. 2a, 2b, 2c, the subject (shape) is presented to the learner by each subset of the foundational attributes; number (first one subject 40 is depicted 50, then two identical 51, and then three identical 52). While card 50 is presented, the auditory presented is “1”; card 51, the auditory is “2” and card 52, the auditory is “3”. For the word presentation, the word is presented from let to right with the first word to the left with the pronouncement, e.g., ‘1 cat’, the two ‘cat’ words, first ‘cat’ being in the identical location on the left hand side of the second word in the middle with the pronouncement, ‘2 cats’. Finally, 3 ‘cat’ words are presented in a row from left to right with the pronouncement, ‘3 cats’.

It will be appreciated that the auditory will vary according to the number of objects presented on the card. Now referring to FIGS. 2d and 2e, size (first a big image 53 of the subject and then an identical small image 54 of the subject or vice versa) is presented. While presenting card 53, the auditory is “big” or “big face” or “big smiley face” and while presenting card 54, the auditory is “little” or “little face” or little smiley face.” It will be appreciated that the auditory will vary according to the depiction presented: for example, if a flower is presented, the auditory for card 53 could be “big” or “big flower.” For the word presentation the word such as ‘cat’ will be presented in very large letters with the pronouncement, ‘big cat’. Then the word ‘cat’ will be presented in small letters with the pronouncement, ‘little cat’. Now referring to FIGS. 2f, 2g and 2h, color (preferably 3 separate images 55, 56, 57 of the subject each presenting the subject as a separate color) are presented with the accompanying appropriate auditory, e.g., “red” (card 55), “yellow” (card 56), “blue” or blue smiley face” (card 57). For a word presentation, a word such as ‘cat’ would be presented in different successive colors. For example, the first card of the color subset would show ‘cat’ in red, second card would present the word ‘cat’ in yellow then in blue. Separate learning modules for each of the subsets can be utilized as follows:

The number subset of the foundation attribute component is modified for the developmental process by presenting shapes or subjects from 1 to 6 in the same configuration as dice. The cards (images are flashed) in order from 1 to 6; 2×'s in a row, then reversed from 6 to one to a final blank ‘all gone’ card. Another modification of the number subset is to select a subject and alternately place a number symbol with the corresponding number of the subject, the images are then flashed rhythmically while announcing 1, one, 2, two, 3, three and so on to 10. This set can also be reversed to the ‘all gone’ card; that is the card with the highest number can be flashed, followed by a lower number and so on until a blank card is flashed with the auditory “all gone” or any desired phrase used consistently with the blank card. For the word modification of the number subset, the words would begin from left to right sequentially adding 1 through 5 words (e.g., ‘cat’), then adding a second line directly underneath the first line adding in sequential order 6 through 10 ‘cat’ words. The order could then be reversed from 10 to 1 back to the ‘all gone’ card.

The “size” subset of the foundation attribute component can be modified for the developmental process by presenting 4 to 6 sets of big and little matching sets of any chosen subject. In presentation of the size concept, the subject matter chosen is first presented in a small or large depiction accompanied by the word “little [subject]” or “big [subject]” as the case may be. For example, using the subject of cats, 5 clear images of different cat faces can be utilized, and each of the 5 cats will have two images: one a big face and one a little face identical to the big face except as to size, equaling 10 total images. The images are then flashed with the auditory pronouncement “Big cat, little cat” for each set. The system is repeated a second time through, dropping the word cat and stepping up the speed saying repetitively only “big, little, big, little, etc.” A third time can be repeated this time using a deep ‘growl’ for ‘big’ cat and a high pitched ‘meow’ for ‘little’ cat. For the word modification one can choose 4 words (they can be rhyming with same phonetic root, or have the same beginning with alternating ending or be words belonging to the same classification, such as ‘animal words’) and present alternating big and little presentations of the word.

The “color” subset of the foundation attribute component can be developmentally modified by selecting a subject and presenting it in the six secondary colors or colors that it naturally occurs in, for example; using a square as the object the six cards would be flashed and announced as, ‘red square’, ‘yellow square’, ‘blue square’, ‘green square’, ‘orange square’, ‘purple square’. The second time through, the speed is preferably increased slightly and the auditory changed to “red, yellow, blue square, green, orange, purple square.” If the presenter repeats a third time he/she may announce the colors only and adding the words, ‘purple squares’ to the last card. Another example, (for dog), black dog, white dog, black and white dog, brown dog, yellow dog (etc.). In order to present this concept, the subject is presented in succession to the learner identically except for changes in color unless the subject is colored by type or kind as long as the classification is consistent. The images are then flashed with the auditory pronouncement of color and subject. The set can be flashed a second time through, speeding up image presentation and announcing only the color. For the word modification one would present the identical word changing only its color for the six secondary colors.

Now referring to FIG. 3, component 3 is the ‘Search Focus and Tracking’ component. This component presents 3 successive identical small images of the subject 60 in separate locations on each card (visual field) 70, 72, 74. The child will search each card for the subject and then focus on it. As soon as a visual lock is seen by the presenter (this generally happens very quickly and within the rhythmical time frame of the set but can be modified to meet the performance requirement), the presenter presents the next image. Once the 3^{rd} subject is in focus the card (image) is rotated 180 degrees and then returned to the vertical position. The auditory is “find it-follow it” for card 74. In practice, as each image is flashed in succession the words, ‘FIND IT’, ‘FIND IT’, ‘FIND IT—follow it!’ are rhythmically announced. The same format is used for word modification. In FIG. 3d, another embodiment of the ‘Search Focus and Tracking’ component as further modified for enhancing the learning experience is illustrated. Here, one selects a subject and presenting 6 to 8 identical small images on different locations on each card (visual field). Cards 1 through 3 to 4 have a blank background, but each depict the same subject, except in different locations on the card. Each successive card (4 or 5 to 6 or 8) has progressively more complex backgrounds from which to ‘find’ the subject. FIG. 3d shows 4 cards with the blank background and 4 with the progressing complex background. The method uses in order color, texture, pattern and design to create a more challenging seek and find experience for each successive image. The first card announces the subject name simultaneously with the image on center of the visual field. Then the next cards are flashed in successive order at the same speed announcing, ‘find it’ with each new image presented. As soon as a visual lock is recognized the image is changed to the next image. The method includes complementing the child at the completion of a set. Sets are commonly repeated through twice and never more than three times. If sets are repeated speed and/or rhythm and or word association should be modified.

Component 4 is the “Functional Attribute” component (FIG. 4). This component presents 3 successive images of the subject that together assist in recognizing ‘what is’ and ‘what is not’ a functional attribute of the subject. The first image is the subject ‘doing’ or ‘being’ something that does not involve any other external thing (internal functional attribute or ‘internal amplitude’). For example, FIG. 4a shows the subject ‘smiley face’ 80 winking. The accompanying auditory would be “winking face.” If the subject were cat, the cat could be licking its mouth, sleeping or hunch backed in fear. The accompanying auditory would change accordingly. The second image is the subject interacting in some way with the external world (external functional attribute or ‘external amplitude’). FIG. 4b shows a ‘smiley face’ 82 on a dress 84. The accompanying auditory would be “smiley face on a dress.” If the subject were cat, the cat could be seen jumping onto a couch, playing with a ball or running from a dog, for example, and the accompanying auditory would change accordingly. The third image shows a humor or absurd image of the subject that while presenting an impossible function of the subject inspires humor and creative thinking. FIG. 4c shows ‘smiley face’ 82 in a daisy 86. If the subject were cat the image could be, ‘little kitty on the big kitty's head!,’ with that accompanying auditory. For word modification of the functional attributes, the above method of an image in the same format above is followed adding the words underneath the image that describe the image function and are identical to the auditory pronouncement. The “Functional Attribute” component of the method can also be used to employ the ‘dialogic reading methodology’ to enhance language development for children able to respond. Instead of ‘flashing’ the image the child can be asked to say what they are seeing on each card. Presenters can then ask questions about the image for further interaction. The “Functional Attribute” component of the methodology can be further modified to enhance the learning experience by selecting a subject and using 3 or 4 images of the subject presenting different ‘internal functional attributes’ of the subject, followed by 3 or 4 different images of ‘external functional attributes’ of the subject. Finally an additional image can be shown with several ‘absurd’ or ‘humorous’ images for the child to notice. If the child is too young to purposefully respond, the presenter can ‘laughingly’ point them out (using an interactive approach) to the child. If the child is capable, they can point out and interact with the presenter concerning what they are seeing. These sets are also flashed rhythmically except for the last card which is presented for interaction. For word modification, the same format above is used only adding the words that are identical to the auditory pronouncement. These may be flashed or they can be read by the child, changing the image as soon as the child or parent (facilitator) reads the words.

Component 5 is the “Visual Acuity” component (FIG. 5). This component (in the final embodiment) presents 2 images; 1 simpler (FIG. 5a) and 1 more difficult (FIG. 5b) for ‘finding’ a small image of the subject 100 ‘hidden’ within a busy background 102, 104. The ability to find a specific subject within a visual field is referred to as visual acuity. The method uses color, texture, simple pattern and simple design 102 for ‘easy’ visual acuity ‘find its’ and chooses one for each set. The method uses complex patterns and designs 104 and chooses one for the ‘difficult’ visual acuity card. The visual acuity components can be modified by creating a set of 6 to 8 images of varying degrees of difficulty in which to find the same subject. Basic or easy sets have one simple background 102 (as described above) that allows baby's as young as 4 to 8 months to locate a simple subject. Horizontal lines of equal width, not too close together is an example of a simple pattern background. A mid level background would be adding another component to the visual field. For example, squiggly closer lines or vertical lines crossing the horizontal lines. The highest level of difficulty would be a background consisting of three or more patterns or designs 104. An example would be ‘find it’ sets of small dog images. The first card would be the image of the dog with the word announced, dog! Cards 2 through 8 present the same dog image but with varying backgrounds for location. As each card is presented the announcement, ‘find it’ accompanies it. The cards for this component are presented only as fast as a child can visually ‘find’ the subject. For word modification the same format as above is followed only instead of finding an image the learner would seek a word.

Component 6 is a “Visual Discrimination” component (FIG. 6). In this component, an anomaly of the subject or recognition of the subject is determined. In the final embodiment 2 discrimination cards are presented; 1 easier (FIG. 6a) and 1 more difficult (FIG. 6b). Subjects can be discriminated (in the method) by color, shape, size, function or kind. The first (easy discrimination) task presents several identical images of a subject 122, excepting one 120 which is identical in all aspects except for color or size. The accompanying auditory would be “find the big smiley face.” The second discrimination image (FIG. 6b) presents either several identical images of the subject excepting one performing a different function (example; for cats, all cats sitting identically while one is sleeping) or several images of different subjects 126 one being the defined subject 124 for the set (this is an example of discrimination by kind—frog, dog and cat on the image—find ‘cat’). Each card is presented individually with the announcement of the task, ‘find the smiley face’ (FIG. 6b) or for other images, ‘find the black cat’ or ‘find the sleeping cat’ for example. For word modification, the same format as above is followed only using identical words for the simple discrimination changing only a color or size of a single word for discrimination. For a more difficult presentation, one would have two or more different words of equal size on the card, one being the correct word for discrimination. The discrimination component can be further modified by presenting sets of 6 to 8 images of a defined subject that must be identified alternately by color, and/or size, and/or shape and/or function and/or kind. Using a square as an example, the first card would show a square in the center of the visual field with the pronouncement ‘square’. The second image would have squares of all the same size with one larger square. The pronouncement, ‘find the big square’ is made as the image is presented. As soon as visual contact or pointing is made and appropriate positive reinforcement occurs the next image is flashed—this image has all black squares with one red square with the associated pronouncement, ‘find the red square’ repeating the above process. The next image would be all circles with one square repeating above procedure. The next card would have only a circle and a square repeating the above procedure. The next card would have many shapes all the same size with only one square repeating the above procedure. The discrimination sets can be further modified by having only color discrimination sets, size sets, shape sets, etc. These cards are presented only as quickly as the child successfully completes the task.

Component 7 is the “Directionality” component (FIG. 7). This component presents two images (FIGS. 7a, 7b) to the child separately to be ‘fixed’ or ‘righted’ individually. The first image is a large image of the subject 140 in the center of the visual field 150 off vertical 90 degrees to the right or left or 180 degrees inverted. The card 150 is presented to the child for ‘fixing’ into a vertical orientation. As the child is presented the card the pronouncement ‘fix it’ is declared. The second directionality card 152 presents a small image of the subject 142 at any defined location on the periphery of the image also 90 degrees off vertical to the right or left or inverted. This card 152 is presented in identical fashion as the previous ‘fix it’ card. Usually children using the method consistently can perform the task independently by 18 months. If the child is younger or for other reasons is incapable of performing the task, the presenter shows the card with the same pronouncement, ‘fix it’ and proceeds to ‘fix it’ themselves with the image in clear view of the child. These cards are interactive and not flashed but presented. The directionality component can be further modified by having a single subject in differing directionalities large and/or small on each of 6 to 8 cards that must be ‘fixed’ or righted and then stacked all ‘correctly’ in the vertical orientation. Another modification is to present a set of different objects in the same categories all possessing directionality for ‘righting’ (for example a set of different animals or different vehicles etc.) or in different categories (e.g. 1 animal, 1 person, 1 auto, 1 boat, 1 tree, etc.) These sets are interactive and not flashed but presented. For word modification, the same format described above is used only presenting a word as the image to be righted.

### EXAMPLE 1

### Build it Component

Now referring to FIGS. 1a, 1b, 1c and 1d, the system chooses a subject, in this example, a smiley face 26. Three or four individual images are presented with corresponding auditory input to assist in recognition of the smiley face. In this example, 1a is flashed simultaneously with the announcement of the word ‘circle’, 1b continues with pronouncement of the word ‘eyes’, 1c continues with pronouncement of the word ‘mouth’ & 1d with the pronouncement of the now recognizable subject as a whole ‘smiley face’. Once the pronouncement of ‘smiley face’ is made the image is rotated to the right or left 180 degrees and then back to vertical. As the image is in the process of turning a second pronouncement of ‘smiley face!’ is made.

### EXAMPLE 2

### Foundation Attribute Component—Number Subset

Now referring to FIGS. 2a, 2b, and 2c, in this example, 2a is flashed simultaneously with the pronouncement ‘one’, 2b is flashed with the pronouncement ‘two’ and 2c with the pronouncement ‘three smiley faces’.

### EXAMPLE 3

### Size Subset

Now referring to FIGS. 2d and 2e, in this example, 2d is flashed with the corresponding pronouncement ‘big smiley face’. 2e is then flashed with the pronouncement ‘little smiley face’.

### EXAMPLE 4

### Color Subset

Now referring to FIGS. 2f, 2g, and 2h, in this example, 2f is flashed simultaneously with the pronouncement ‘red’. 2g continues with ‘yellow’ and 2h continues with ‘blue smiley face’.

### EXAMPLE 5

### Search Focus and Tracking Component

Now referring to FIGS. 3a, 3b, and 3c, in this example, 3a is flashed simultaneously with the words, ‘find it’. This is repeated with image 3b & 3c. Once 3c is flashed with the pronouncement ‘find it’ the figure along with the entire visual field (card) is rotated progressively 180° to the right or left until it can be viewed upside down and then is turned back to its original position with the pronouncement ‘follow it.’

### EXAMPLE 6

### Functional Attribute Component

Now referring to FIGS. 4a, 4b and 4c, in this component the subject the first card presents an image of an ‘internal functional attribute’ of the subject, the second card presents an ‘external functional attribute’ of the subject, the third card presents a humorous or absurd function of the subject. 4a is flashed with the pronouncement, ‘smiley face is winking’. 4b is then flashed with the pronouncement ‘smiley face on a dress!’ 4c is then flashed with the pronouncement, ‘smiley face in a daisy!’

### EXAMPLE 7

### Visual Acuity Component

Components 5a and 5b hide the subject within a visually stimulating background. The ‘a’ card will be a simple background such as a field of similar equally distant vertical lines 102; the ‘b’ card will be a more complex background such as a combination of designs 104. 5a is presented to the child (not flashed) with the pronouncement, ‘find it’. The parent or instructor holds the card in an orientation conducive to the child's ability to search for it. The child will then search for the hidden subject 100. Younger children will acknowledge ‘finding it’ by generally steadying a wide eyed focus on the subject. Older children will point. Upon recognition of ‘finding it’ an immediate cheering by the parent or instructor occurs to reinforce successful achievement of the goal. 5b is then presented to the child with the pronouncement, ‘find it’. The process is repeated. If the child is unable to ‘find it’ after several seconds, the instructor should brush their hand over the quadrant in which the subject is located repeating, ‘find it’ to help the child in his search. After several more seconds if the child still cannot ‘find it’ the parent/instructor should point it out and clearly announce in an animated tone, ‘here it is!’, engaging the child to finally see it and be rewarded for ‘finding it’ with cheering.

### EXAMPLE 8

### Visual Discrimination Component

The visual discrimination components 6a and 6b, take advantage of the natural cognitive ability to visually seek out an anomaly on an otherwise consistent visual field while simultaneously introducing the understanding of distinguishing between color, shape, size, function or kind. 6a is always an easy discrimination task (as defined above) flashed with the pronouncement, ‘find the big smiley face’. The card is presented to the child in an orientation conducive for visually ‘finding it’. The child will scan the card and generally be drawn to the anomaly on the page which is the big face 120. The parent or instructor follows a younger child's eyes until it rests upon the anomaly ‘big face’ upon which the child is reinforced with cheers for successfully accomplishing the task. If the child has trouble initially the presenter can brush their hand over the correct quadrant to assist the child. Finally, if the child still has trouble locating the subject, the presenter points to it with the joyful announcement, ‘here it is!’ or ‘big smiley face!’ The second card in this component is always a more difficult card as defined above. 6b is then flashed with the pronouncement, ‘find the smiley face’. Repeat 6a presentation format.

### EXAMPLE 9

### Visual Directionality Component

Now referring to FIGS. 7a and 7b, 7a will be a large representation of the subject 140 in the center of the visual field. 7b will be a small representation of the subject 142 to be located on the periphery of the screen or card or page. The subject on each card is turned 90 degrees to the right or left or 180 degrees inverted. 7a shows the larger subject as described above. The child is presented the card with the pronouncement, ‘fix it’. If the child does not respond within a few seconds to attempt to turn the card to place the subject in the upright position, the parent or instructor reclaims the card and ‘fixes it’ to the upright position in view of the child. 7b will show the smaller subject. The child is presented 7b with the pronouncement, ‘fix it’. The above procedure is repeated rewarding the child for successful accomplishment.

I claim:

1. A method of education, comprising:
presenting to a learner a set of images on a visual field, which set imparts a concept, wherein each of said images in said set is presented individually concurrently with an auditory pronouncement, wherein each image and auditory pronouncement is presented in two seconds or less to said learner.

2. The method of claim 1, wherein said concept is building a whole subject from its component parts, and wherein said set is presented in a predetermined order to said learner, and wherein a first image in said set depicts one component part of a subject matter and each successive member of said set depicts an additional portion of said subject matter as compared with the preceding member.

3. The method of claim 1, wherein said concept is quantity of a subject matter, and wherein said set is presented in a predetermined order to said learner, and a first image in said set depicts said subject matter a whole, and each successive image comprises one or more additional depictions of said subject matter as a whole as compared with the preceding image.

4. The method of claim 1, wherein said set comprises a series of images presented to the learner which images depict the same subject matter in different colors or sizes.

5. The method of claim 1, wherein said concept is location and wherein a series of images are presented to the learner depicting the same subject matter in differing locations in the visual field.

6. The method of claim 1, wherein said concept is functional attributes of a subject wherein said set is presented in a predetermined order to said learner, and a first image in said set depicts said subject matter having one attribute, and each successive image in said set depicts the same subject matter but with a varied functional attribute.

7. The method of claim 1, wherein said concept is visual acuity.and wherein said set is presented in a predetermined order to said learner, and a first image in said set depicts said subject matter on a first background, and each successive image depicts an identical subject matter on successive backgrounds which progressively increase in complexity.

8. The method of claim 1, wherein a plurality of images is presented to the learner and wherein a subject matter is depicted on each image in a position which differs from conventional depiction of said image.

9. The method of claim 2, wherein said concept is quantity of a subject matter, and wherein said set is presented in a predetermined order to said learner, and a first image in said set depicts said subject matter a whole, and each successive image comprises one or more additional depictions of said subject matter as a whole as compared with the preceding image.

10. The method of claim 9, wherein said set comprises a series of images presented to the learner which images depict the same subject matter in different colors.

11. The method of claim 10, wherein said concept is location and wherein a series of images are presented to the learner depicting the same subject matter in differing locations in the visual field.

12. The method of claim 11, wherein said concept is functional attributes of a subject wherein said set is presented in a predetermined order to said learner, and a first image in said set depicts said subject matter having one attribute, and each successive image in said set depicts the same subject matter but with a varied functional attribute.

13. The method of claim 12, wherein said concept is visual acuity, and wherein said set is presented in a predetermined order to said learner, and a first image in said set depicts said subject matter on a first background, and each successive image depicts an identical subject matter on successive backgrounds which progressively increase in complexity.

14. The method of claim 13, wherein a plurality of images is presented to the learner and wherein a subject matter is depicted on each image in a position which differs from conventional depiction of said image.

15. An educational method, wherein a learner is presented with a series of images accompanied by auditory input, comprising presenting a single subject to the learner by structural attributes, foundational attributes, functional attributes, and location attributes.

16. The method of claim 15, wherein the subjects are presented in a rapid rhythmical manner.

17. The method of claim 15 or 16, further comprising input to stimulate kinesthetic response from said learner.

18. The method of claim 15 or 16 wherein passive learning is stimulated.

19. The method of claim 17, wherein passive learning is stimulated.

20. The method of claim 15 or 16, wherein said method requires interaction from said learner.

21. The method of claim 17, wherein said method requires interaction from said learner.

22. An educational system, comprising a first set comprising a plurality of images on a medium providing a visual field having a background, which medium may be displayed individually to a subject in a predetermined order, one of said images depicting a component part of a subject matter; and the other images depicting a different portion of said subject matter as compared with each of the other images.

23. The system of claim 22, further comprising a second set comprising a plurality of images wherein a first image of said second set depicts said subject matter as a whole, said second image depicts two of said subject matter as a whole, and each successive image of said set depicts an additional image of said subject matter as a whole as compared with the preceding member.

24. The system of claim 23, further comprising a third set comprising a plurality of images, wherein each image depicts said subject matter as a whole in a color differing from each of the other images.

25. The system of claim 24, further comprising a fourth set comprising a plurality of images, wherein a first image depicts a subject matter in a first location on said visual field and each additional image depicts said subject matter in a location on said visual field differing from the location of the other images in said fourth set.

26. The system of claim 24 or 25, wherein said background has a variation on each medium on which said images are displayed.

27. The system of claim 26, wherein said variation is selected from colors and patterns.

28. The system of claim 27, wherein said variation is selected from checkerboard, dots, or plaid.

29. The system of claim 26 wherein said pattem is a complex random pattern.

30. An educational system, comprising a set comprising a plurality of successive images, each image depicting a different functional attribute of a single subject.

31. The system of claim 30, wherein said images depict an internal functional attribute of said subject.

32. The system of claim 30 or 31, wherein said images depict an external functional attribute of said subject.

33. The system of claim 30 or 31, wherein said images depict said subject in a humorous or absurd manner.

34. The system of claim 32, wherein said images depict said subject in a humorous or absurd manner.

35. An educational system for visual acuity, comprising a set comprising a plurality of images, each successive image said set depicting an identical subject on an increasingly complex background as compared with the immediately preceding member.

36. The system of claim 35, wherein said subject is placed in a different location on successive members of said set.

37. An educational system for visual discrimination, comprising a first set comprising a plurality of members each with multiple images of a single subject matter, each of said displays differing from the other displays with respect to an attribute.

38. The system of claim 37, wherein said attributes are selected from size, color, shape and activity depiction.

39. An educational system for visual discrimination, comprising a set comprising a plurality of successive members each with multiple images, each of said images differing from the other images on said members by subject matter.

40. An educational system for visual directionality, comprising a set comprising a plurality of successive members each with a single display of an image, each successive member of said set depicting said image in a position which differs from conventional depiction of said image.

41. The system of claim 40, wherein said image is depicted upside down or at an angle.

42. An educational system for visual directionality, comprising a first set comprising a plurality of successive members each member depicting a single display of an image, wherein said image depicted on each successive member of said set is of a different subject matter and wherein said image is depicted in a position which differs from conventional depiction of said image.

43. The system of claim 42, wherein said different subject matter comprises images in the same category.

44. The system of claim 43, wherein said different subject matter comprise images in different categories.

45. An integrated educational system, comprising component sets of images which impart concepts to a learner, wherein a first set of images provides a concept of building a whole image from component parts and a second set provides a concept of foundation attributes selected from the group consisting of numbers, colors and size.

46. The integrated system of claim 45, further comprising a search, focus and tracking component which provide images directed to the concept of search, focus and tracking.

47. The integrated system of claim 45 or 46, further comprising a functional attribute component which provides images directed to the concept of functional attributes of a subject matter.

48. The integrated system of claim 45 or 46 further comprising a visual acuity component.

49. The integrated system of claim 47, further comprising a visual acuity component.

50. The integrated system of claim 45 or 46, further comprising a visual discrimination component.

51. The integrated system of claim 47, further comprising a visual discrimination component.

52. The integrated system of claim 48, further comprising a visual discrimination component.

53. The integrated system of claim 45 or 46, further comprising a visual directionality component.

54. The integrated system of claim 47, further comprising a visual directionality component.

55. The integrated system of claim 48, further comprising a visual directionality component.

56. The integrated system of claim 49, further comprising a visual directionality component.

57. The integrated system of claim 50, further comprising a visual directionality component.

58. The integrated system of claim 51, further comprising a visual directionality component.

59. The integrated system of claim 52, further comprising a visual directionality component.
